(19) United States
(12) Patent Application Publication
(10) Pub. No.: US 2023/0114640 A1
(43) Pub. Date: Apr. 13, 2023

(54) METHODS AND SYSTEMS FOR FACILITATING BUILDING RELATIONSHIP BETWEEN BUSINESS AND CONSUMERS

(71) Applicant: Patrick Greer-Moroney, Beacon, NY (US)

(72) Inventor: Patrick Greer-Moroney, Beacon, NY (US)

(21) Appl. No.: 17/963,890

(22) Filed: Oct. 11, 2022

Related U.S. Application Data
(60) Provisional application No. 63/254,481, filed on Oct. 11, 2021.

(51) Int. Cl. G06Q 30/02; G06Q 50/00; G06Q 20/20

(52) U.S. Cl. CPC G06Q 30/0282; G06Q 50/01; G06Q 30/0201; G06Q 30/0214; G06Q 20/20

(57) ABSTRACT

Disclosed is a system and method of facilitating building relationship between business and consumers.

The current application claims a priority to the U.S. provisional patent application Ser. No. 63/254,481 filed on Oct. 11, 2022.

### FIELD OF THE INVENTION

The present invention relates generally to data processing. More specifically, the present invention is methods and systems for facilitating building relationship between business and consumers.

### BACKGROUND OF THE INVENTION

The field of data processing is technologically important to several industries, business organizations, and/or individuals.

Word of mouth is the standard for all successful local business relationships. With covid, local businesses have now been put in a place where in-person traffic has mitigated their ability to reach customers to create the bonds that facilitate a strong word of mouth relationship. Existing techniques for facilitating building relationships between businesses and consumers are deficient with regard to several aspects relating to in-person consumer and local business relationships. For instance, current technologies (such as social media and web-based channels) facilitate building relationships but lack the ability for businesses to outsource marketing directly where it would create a significant reason for a consumer to come in person. When individuals post/tag/take a photo at a participating business, that is take these actions at the actual in-person location, current technologies do not track metrics (such as the tag, photo, etc.) to be utilized in their next purchase at a business, like an employee holding a sign or referring someone with word of mouth. Further, current technologies do not facilitate brokering the relationship allowing businesses to establish (Pay for Posting) incentives utilizing their most marketable asset. Further, current technologies create a pathway for businesses to interact with customers and vice versa. Also, current technologies do not facilitate interlinked tracking that allows the business to establish a stronger digital ‘word of mouth’ relationship with a user. Furthermore, current technologies do not allow a business to track who gives them free advertising when the business tags/shares/and posts relating to the customers.

Therefore, there is a need for improved methods and systems for facilitating building relationships between business and consumers that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method for facilitating building relationship between business and consumers is disclosed. Accordingly, the method may include receiving, using a communication device, a user identifier from at least one user device associated with at least one user. Further, the method may include retrieving, using a storage device, a user registration module based on the user identifier. Further, the method may include transmitting, using the communication device, the user registration module to the at least one user device. Further, the method may include receiving, using the communication device, user details corresponding to the user registration module from the at least one user device. Further, the method may include analyzing, using a processing device, the user details and the user registration module for generating a user account. Further, the method may include receiving, using the communication device, a content of a user activity from at least one input device. Further, the method may include transmitting, using the communication device, the content to an external server. Further, the method may include processing, using the processing device, the content. Further, the method may include identifying, using the processing device, a verification associated with a user activity based on the processing. Further, the method may include determining, using the processing device, metrics based on the processing. Further, the method may include determining, using the processing device, a word-of-mouth activity based on the determining of the metrics. Further, the method may include determining, using the processing device, a reward token based on the word-of-mouth activity. Further, the method may include transmitting, using the communication device, the reward token to at least one customer device associated with the at least one customer. Further, the method may include storing, using the storage device, the reward token, a verification, and the word-of-mouth activity on a blockchain.

According to some aspects, a system for facilitating building relationship between business and consumers is disclosed. Accordingly, the system may include a communication device configured for receiving a user identifier from at least one user device associated with at least one user. Further, the communication device may be configured for transmitting the user registration module to the at least one user device. Further, the communication device may be configured for receiving user details corresponding to the user registration module from the at least one user device. Further, the communication device may be configured for receiving a content of a user activity from at least one input device. Further, the communication device may be configured for transmitting the content to an external server. Further, the external server may be associated with a social media platform. Further, the communication device may be configured for transmitting a reward token to at least one customer device associated with the at least one customer. Further, the system may include a processing device configured for analyzing the user details and the user registration module for generating a user account. Further, the processing device may be configured for processing the content. Further, the processing device may be configured for identifying a verification associated with a user activity based on the processing. Further, the processing device may be configured for determining metrics based on the processing. Further, the processing device may be configured for determining a word-of-mouth activity based on the determining of the metrics. Further, the processing device may be configured for determining the reward token based on the word-of-mouth activity. Further, the system may include a storage device configured for retrieving the user registration module based on the user identifier. Further, the storage device may be configured for storing the reward token, the verification, and the word-of-mouth activity on a blockchain.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a screenshot of a registration user interface of the software platform associated with the disclosed system, in accordance with some embodiments.

FIG. 3 is a screenshot of a registration user interface of the software platform associated with the disclosed system, in accordance with some embodiments.

FIG. 4 is a flow diagram of a method for facilitating registration of the user for facilitating building relationship between business and consumers, in accordance with some embodiments.

FIG. 5 is a flow diagram of a method for transmitting user data from social media API to a server for facilitating building relationship between business and consumers, in accordance with some embodiments.

FIG. 6 is a screenshot of a user interface of the software platform associated with the disclosed system, in accordance with some embodiments.

FIG. 7 is a screenshot of a user interface of the software platform associated with the disclosed system, in accordance with some embodiments.

FIG. 8 is an illustration of a unique token associated with the user, in accordance with some embodiments.

FIG. 9 is an illustration of a unique purchase token associated with the business, in accordance with some embodiments.

FIG. 10 is a flow diagram of a method for storing the data in the backend server for facilitating building relationship between business and consumers, in accordance with some embodiments.

FIG. 11 is a flow diagram of a method for facilitating building relationship between business and consumers, in accordance with some embodiments.

FIG. 12 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating building relationship between business and consumers, embodiments of the present disclosure are not limited to use only in this context.

### Overview

The present disclosure describes methods and systems for facilitating building relationship between business and consumers. Further, the disclosed system may be configured for facilitating building digital word-of-mouth partnerships where customers may be incentivized to post real-life content on behalf of the business. Further, the disclosed system may locally track user data created at networked establishments and create a link between the user and the business, and provide brokering of beneficial rebates and rewards.

Word of mouth is the standard for all successful local business relationships. With covid local businesses have now been put in a place where in-person traffic has mitigated their ability to reach customers to create the bonds that facilitate a strong word of mouth relationship. Further, when individuals post/tag/take a photo at a participating business, the disclosed system may track metrics to be utilized in their next purchase at the business. Further, the disclosed system may facilitate brokering that relationship allowing businesses to establish (Pay for Posting) incentives utilizing their most marketable asset e.g.: Customers/Items at their establishments which is markets via the customers posting.

Some conventional technologies allow for users to share and tag. Each share and tag are a quantifiable metric that tracks exposure to other users, as such, each share and tag act as a form of advertising that benefits the business being tagged. It does this, in the same way, a billboard on the side of the road or a television plug would.

Further, the disclosed system may be associated with an interlinked tracking system that allows the business to establish a digital ‘word of mouth’ relationship with a user. Further, the disclosed system allows the business to track who gives them free advertising when they tag/share/and post negating the customer and the business. Further, the disclosed system may facilitate providing one of the most beneficial relationships a small business can have which may be a customer referral.

Further, the disclosed system may be associated with a software platform (such as an application) that creates a link between registered users and the businesses on the platform.

When a user arrives in -person at a participating business and takes a photo, the disclosed system may use metrics associated with the photo from the existing analytics extracted from the social media platform to establish that a word-of-mouth transaction has taken place. Further, the disclosed system may do so by tracking specific, and related metrics, such as views, likes, shares, impressions, and other exposure-based qualities.

Further, the disclosed system may facilitate recording and extrapolating the metrics. Further, upon recording and extrapolating at the time of purchase, the disclosed system may show a specific post and correlating metrics on the application dashboard for that user to validate this word-of-mouth activity.

Further, an original and unique verifiable token may be created. Further, the token may be reflective of a rebate, discount, or another vendor-specific incentive to reward the user's word-of-mouth posting.

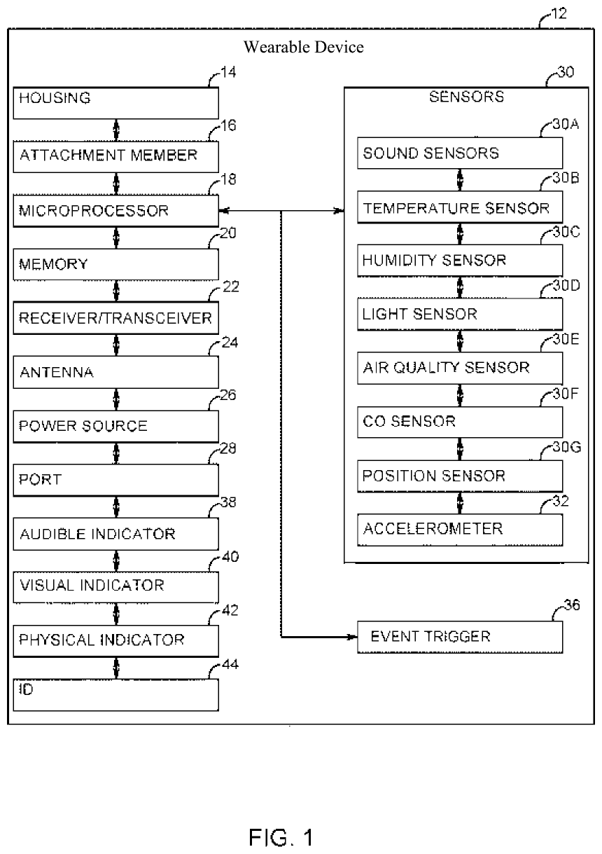

FIG. 1 is an illustration of an online platform 100 consistent with various embodiments of the present disclosure. By way of non-limiting example, the online platform 100 for facilitating building relationship between business and consumers may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, service providers, service consumers, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 1200.

In further embodiments, a method for facilitating building relationship between business and consumers is disclosed. Accordingly, the method may include receiving, using a communication device, a user identifier from at least one user device associated with at least one user. Further, the user identifier may facilitate determining an identity of the at least one user. Further, the identity may include a business organization and a customer. Further, the at least one user may include an individual, an institution, and an organization that may want to build relationship based on a purchase. Further, the at least one user device may include a smartphone, a mobile, a tablet, a personal computer, and so on.

Further, the method may include retrieving, using a storage device, a user registration module based on the user identifier. Further, the user registration module may include a plurality of fields that may be answered by the at least one user for registering the at least one user.

Further, the method may include transmitting, using the communication device, the user registration module to the at least one user device.

Further, the method may include receiving, using the communication device, user details corresponding to the user registration module from the at least one user device. Further, the user details may include a username, a contact number, email address, a contact address, etc.

Further, the method may include analyzing, using a processing device, the user details and the user registration module for generating a user account. Further, the generating of the user account may facilitate registering of the at least one user on the software platform. Further, the user account may be associated with a user id and password.

Further, the method may include receiving, using the communication device, a content of a user activity from at least one input device. Further, the content may include audio, image, audio-video. multimedia, etc. Further, the at least one input device may include a smartphone, a tablet, a laptop, a computer, a camera, a microphone, a location sensor, etc. Further, the user activity may include at least one customer capturing the content at a location.

Further, the method may include transmitting, using the communication device, the content to an external server. Further, the external server may be associated with a social media platform.

Further, the method may include processing, using the processing device, the content.

Further, the method may include identifying, using the processing device, a verification associated with a user activity based on the processing. Further, the verification may include verifying a location of the user activity. Further, the verifying may include confirming the location of the content associated with the user activity.

Further, the method may include determining, using the processing device, metrics based on the processing. Further, the metrics may include views, likes, comments, shares, etc.

Further, the method may include determining, using the processing device, a word-of-mouth activity based on the determining of the metrics. Further, the word-of-mouth activity may include the at least one customer recommending at least one business associated with at least one business administrator. Further, the at least one business administrator may include an individual, an institution, and an organization.

Further, the method may include determining, using the processing device, a reward token based on the word-of-mouth activity generated through the behaviors described above.

Further, the method may include transmitting, using the communication device, the reward token to at least one customer device associated with the at least one customer. Further, the at least one customer device may include a smartphone, a mobile, a tablet, a laptop, etc. Further, the reward token may include a discount, a rate, etc.

Further, the method may include storing, using the storage device, the reward token, a verification, and the word-of-mouth activity on a blockchain. Further, the Blockchain components may be used to sole fund the local businesses within the network on in-store purchases.

Further, in some embodiments, the method may include generating, using the processing device, crypto token based on the word-of-mouth activity. Further, the crypto token may be associated with a cryptocurrency. Further, the method may include transmitting, using the communication device, the crypto token to the at least one customer device.

Further, in some embodiments, the method may include receiving, using the processing device, sensor data from at least one sensor. Further, the at least one sensor may include a physiological sensor, an audio sensor, point of sale (Pos System), etc. Further, the physiological sensor may be configured for determining emotions of the at least one customer. Further, the determining of the word-of-mouth activity may be based on the sensor data.

Further, in some embodiments, the user account may be associated with a digital wallet configured for storing transaction information associated with the reward tokens. Further, the digital wallet may be configured for storing the reward tokens.

In further embodiments, a system for facilitating building relationship between business and consumers is disclosed. Accordingly, the system may include a communication device configured for receiving a user identifier from at least one user device associated with at least one user. Further, the user identifier may facilitate determining an identity of the at least one user. Further, the identity may include a business organization and a customer. Further, the at least one user may include an individual, an institution, and an organization that may want to build relationship based on a purchase. Further, the at least one user device may include a smartphone, a mobile, a tablet, a personal computer, and so on. Further, the communication device may be configured for transmitting the user registration module to the at least one user device. Further, the communication device may be configured for receiving user details corresponding to the user registration module from the at least one user device. Further, the user details may include a username, a contact number, email address, a contact address, etc. Further, the communication device may be configured for receiving a content of a user activity from at least one input device. Further, the content may include audio, image, audio-video. multimedia, etc. Further, the at least one input device may include a smartphone, a tablet, a laptop, a computer, a camera, a microphone, a location sensor, etc. Further, the user activity may include at least one customer capturing the content at a location. Further, the communication device may be configured for transmitting the content to an external server. Further, the external server may be associated with a social media platform. Further, the communication device may be configured for transmitting a reward token to at least one customer device associated with the at least one customer. Further, the at least one customer device may include a smartphone, a mobile, a tablet, a laptop, etc. Further, the reward token may include a discount, a rate, etc.

Further, the system may include a processing device configured for analyzing the user details and the user registration module for generating a user account. Further, the generating of the user account may facilitate registering of the at least one user on the software platform. Further, the user account may be associated with a user id and password. Further, the processing device may be configured for processing the content. Further, the processing device may be configured for identifying a verification associated with a user activity based on the processing. Further, the verification may include verifying the location of the user activity. Further, the verifying may include confirming the location of the content associated with the user activity. Further, the processing device may be configured for determining metrics based on the processing. Further, the metrics may include views, likes, comments, shares, etc. Further, the processing device may be configured for determining a word-of-mouth activity based on the determining of the metrics. Further, the word-of-mouth activity may include the at least one customer recommending at least one business associated with at least one business administrator. Further, the at least one business administrator may include an individual, an institution, and an organization. Further, the processing device may be configured for determining the reward token based on the word-of-mouth activity.

Further, the system may include a storage device configured for retrieving the user registration module based on the user identifier. Further, the user registration module may include a plurality of fields that may be answered by the at least one user for registering the at least one user. Further, the storage device may be configured for storing the reward token, the verification, and the word-of-mouth activity on a blockchain.

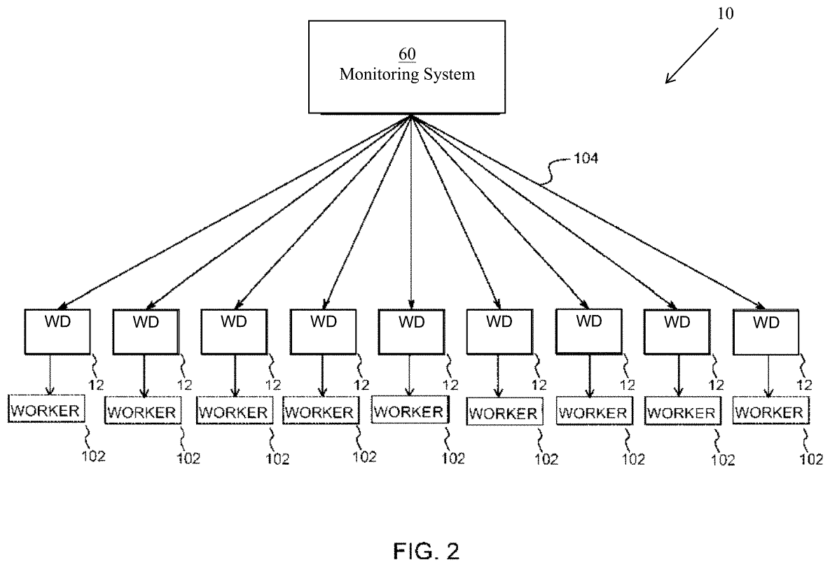

FIG. 2 is a screenshot of a registration user interface of the software platform associated with the disclosed system, in accordance with some embodiments. Accordingly, the user interface may facilitate providing a login token for users to register onto the software platform and download applications, utilizing their social media credentials. The registration user interface may facilitate accessing and logging into the application. This is where the application's users are identified, client or business, giving them access to their unique interface.

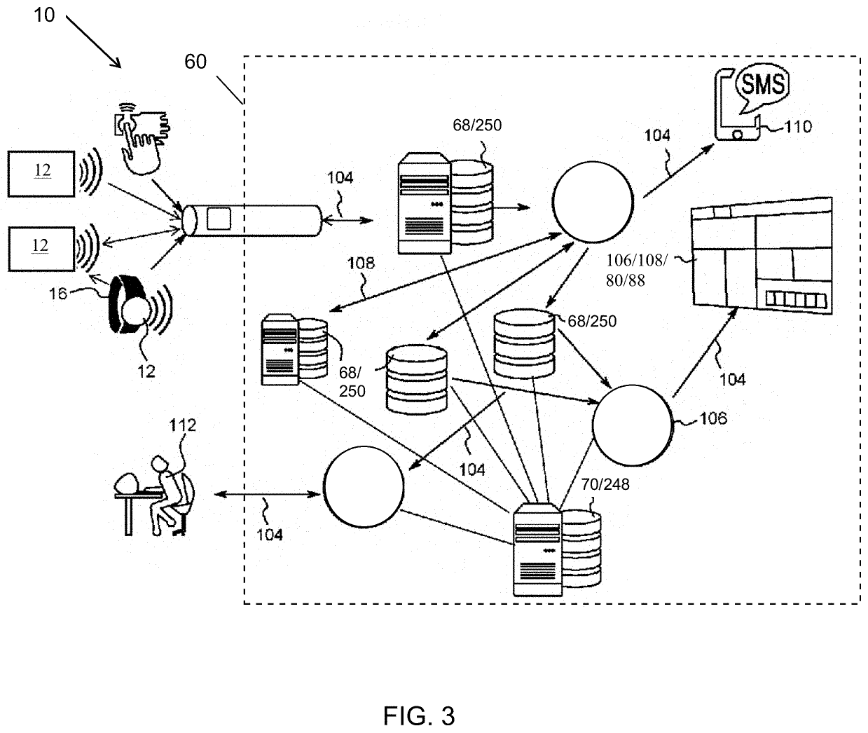

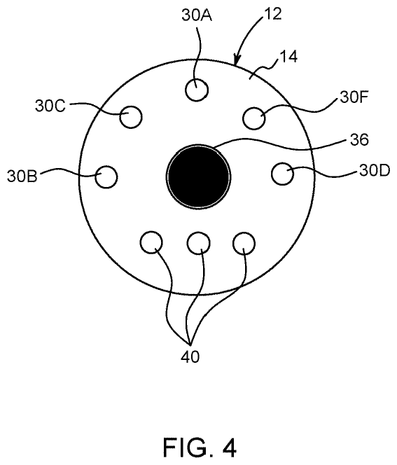

FIG. 3 is a screenshot of a registration user interface of the software platform associated with the disclosed system, in accordance with some embodiments. Accordingly, the login token may provide options for those identifying as a user (Customer) or Business to register themselves on the software platform enabling the user or the business to access the corresponding dashboard and services related to their role. Further, the user interface may facilitate allowing users to differentiate their role on the software platform. The business may be allocated one hub and service while the users may be allotted a second hub and service. Each option (or the hub and the second hub) may install a different user interface enabling each to access the relevant interface for each profile.

FIG. 4 is a flow diagram of a method for facilitating registration of the user for facilitating building relationship between business and consumers, in accordance with some embodiments. Accordingly, once users' registers, the method may include the disclosed application accessing social media API associated with the application users. In the API, the disclosed system may record and transmit the relevant data to servers to be utilized for each member's account. Further, metrics associated with the data may validate and qualify the activities establishing the relationship between the client and the business. Further, the disclosed system may facilitate generating a link between the participating/registered business and the registered user, linking them to the disclosed system. Further, the disclosed system may use the latest version of the social media platforms. Further, the disclosed system may be configured for saving tokens into a database (or the server). Further, the disclosed system may use to track data from social media platforms. Further, for business, the disclosed systems store check-in/geotag/point of sale (POS) at a location. Further, for the users, the disclosed systems store images taken at check-in/geotag location.

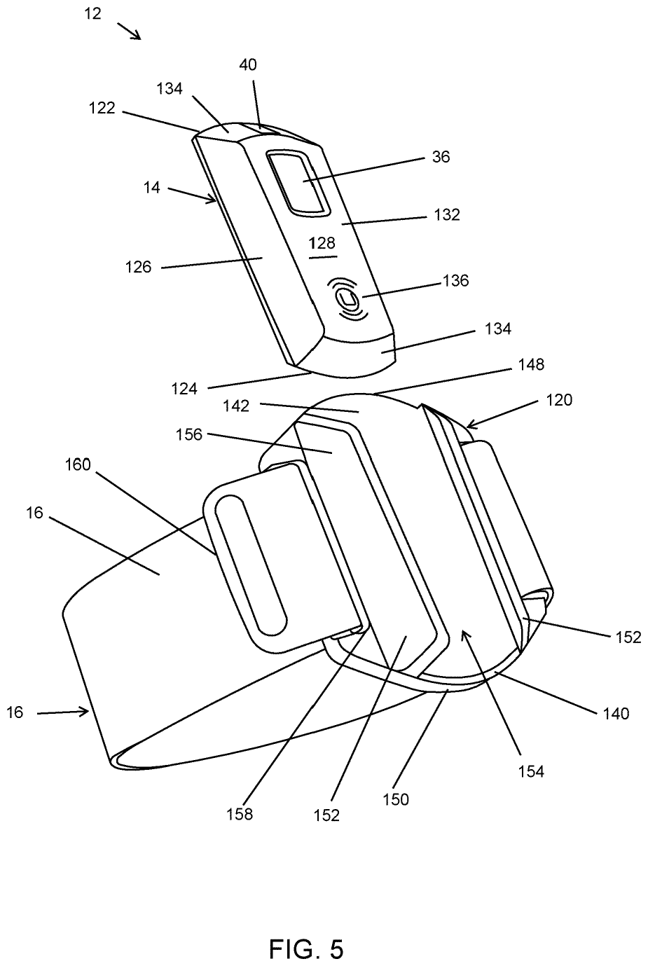

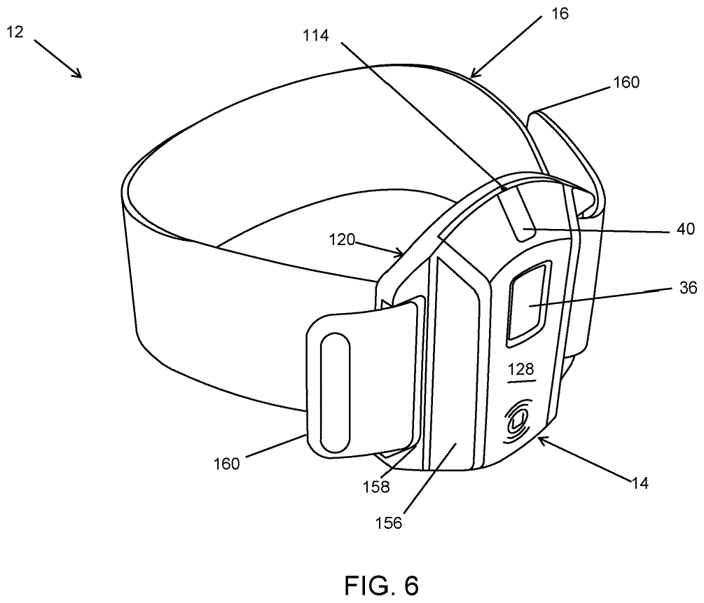

FIG. 5 is a flow diagram of a method for transmitting user data from social media API to a server for facilitating building relationship between business and consumers, in accordance with some embodiments. Accordingly, the method may include receiving user data from the user using the media API. Further, the method may include transmitting the metric associated with the user data to a backend hub. Further, the disclosed system may be configured for tracking the metrics associated between the user and business and automatically identifying posting that meets the set criteria, which is posting within the Geotagging/location-based that is reflective of the participating businesses. Further, the data is then sent to the server to be recorded.

Further, the disclosed system may track, organize, and differentiate different metrics as they relate to postings made based on the application's criteria. Further, data associated with the metrics may be then stored on the disclosed system to be tracked and translated to verifiable data that may be later shown on the Verification Token. The verification token is the key that unlocks the reimbursement of the transaction, once a token is created.

Once registered, data is tracked and collected from Clients FB/IG API to be sent to the backend hub. Data collected is Geotag's/Checkins of the registered businesses enrolled in locally program. Once a client uses the “check in” Feature, Locally, an exemplary embodiment of the disclosed system verifies through API to verify Geotag and tracks views only (Unless other metrics seem doable).

FIG. 6 is a screenshot of a user interface of the software platform associated with the disclosed system, in accordance with some embodiments. Accordingly, the user interface facilitates transferring the data stored on the backend hub or the server detailing relevant metrics on the display. Further, the user interface facilitates displaying a timestamp of each post in relation to the participating business it was taken at. Along with options to display the post via a Verification button, the users may see participating businesses displayed on a geographic map. Each business and its unique promotions may be displayed as well informing the user of offers available through this promotion. Further, the user interface displays a map showing locations and current promotions of the participating businesses.

Further, the data may be stored on the backend server (or hub) as it relates to the user's recorded activity such as when and where the photo was taken. Further, the disclosed system tracks actions taken on location at participating and provides a verification button that can be manipulated to view photos at the time of purchase revealing their token.

Further, the user interface allows the users to see where participating businesses are and whether or not they have taken a photo there. Upon clicking Verify Button, a QR Code or Geotag allows the users to connect with the business upon follow-up visit.

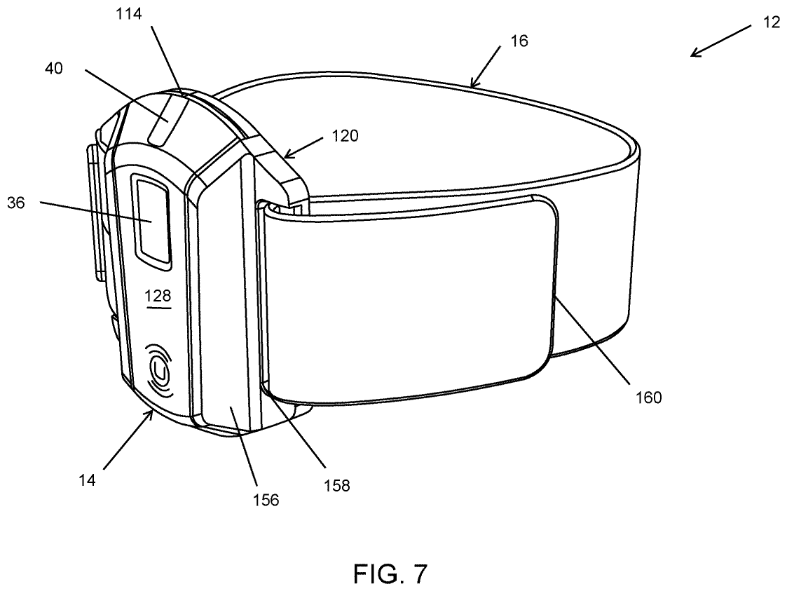

FIG. 7 is a screenshot of a user interface of the software platform associated with the disclosed system, in accordance with some embodiments. Accordingly, the user may interface may be associated with the business. Further, the user interface displays relevant metrics associated with each user who has participated at their location. Each user's profile may be contacted by the business directly via a contact button. Top customers are displayed that allows the business to interact with those who have interacted with the business the most. Further, the user interface may include a geographic map to illustrate which other businesses are participating and their promotions. Further, the disclosed system allows the business to verify customer images when In Store using Geotag or QR Code when they verify.

Activity indicating customers' participation and activities are reflected in the user interface. The business may verify activity and tokens and may reach out to each user individually as the data is reflective of users' behaviors. Additionally, the user interface also shows a geographical map of participating businesses and their promotions/incentives as well.

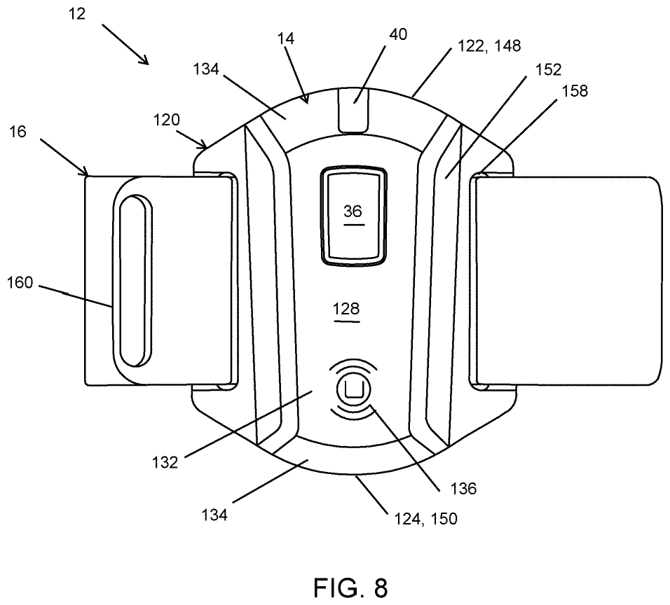

FIG. 8 is an illustration of a unique token associated with the user, in accordance with some embodiments. Accordingly, the unique token may be a QR code that may be scanned or visually verified by the business upon time of purchase. Further, the QR code may be a scannable code that acts as a token to signify and finalize the word-of-mouth transaction. Further, the unique token may also show a photo/Tag/Geotag to further validate the content or customized content to achieve the same thing. Further, the QR code may be scanned along with an identifiable number for manual implementation. Further, the unique token may include an image reflecting the post that may be stored and saved on both the client's back-end server and the business's back-end servers. FIG. 8 shows relevant metrics pulled from the API illustrating relevant quantifiable value metrics such as Views, Shares, Likes, etc. After Clicking Verify Button, a duplicate of the image, as well as the QR code (or verifiable QR Code), appears with Views/Metrics

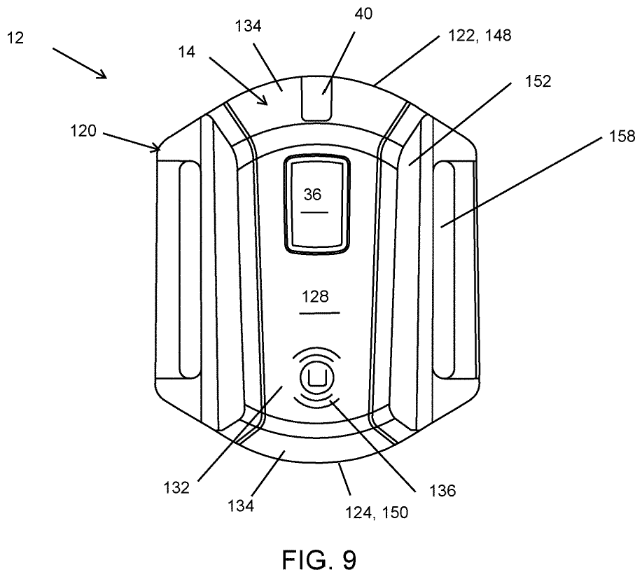

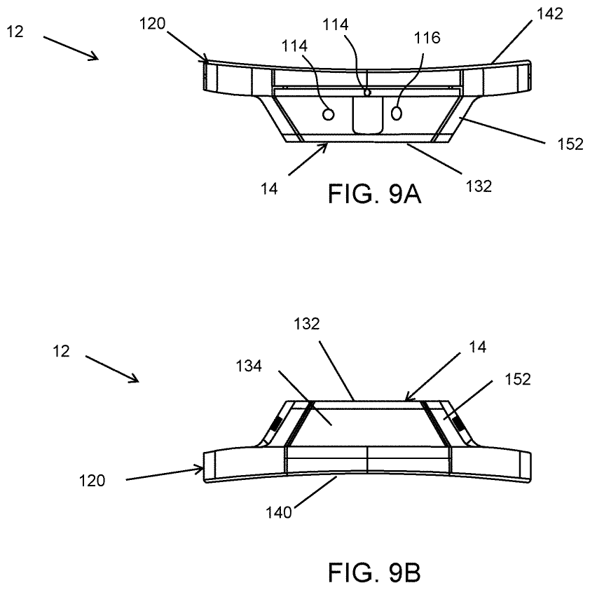

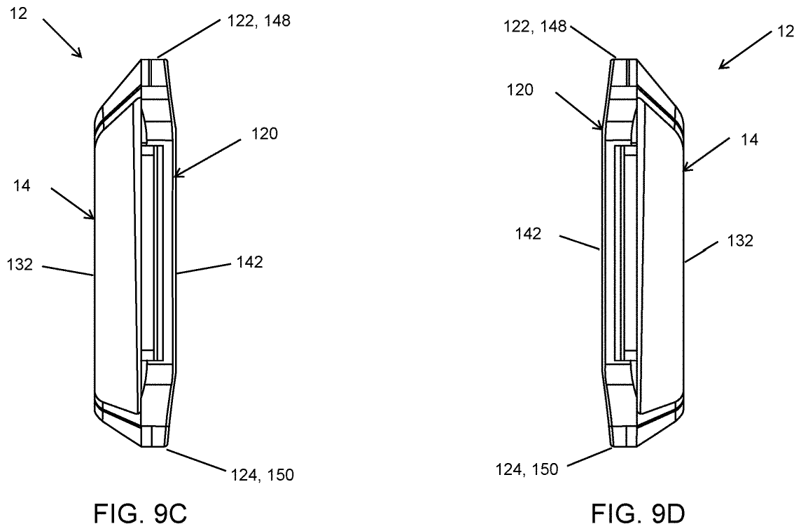

FIG. 9 is an illustration of a unique purchase token associated with the business, in accordance with some embodiments. Once the user presents the unique token, the business may scan the token, via their camera, to see a mirrored version of the token on their device. The token may be accessed via a user hub, associated with the disclosed system, which has tracked this image on the back-end server.

The token may illustrate the valuable metrics from the API like Views, Impressions, Shares, and may also provide a confirm button. The confirm button may lock out the image from duplicate use while registering it on the backend server at the time of purchase. Further, upon clicking Confirm or Scanning QR Code, an image associated with the unique token may be recorded on the backend server preventing the image from being used again.

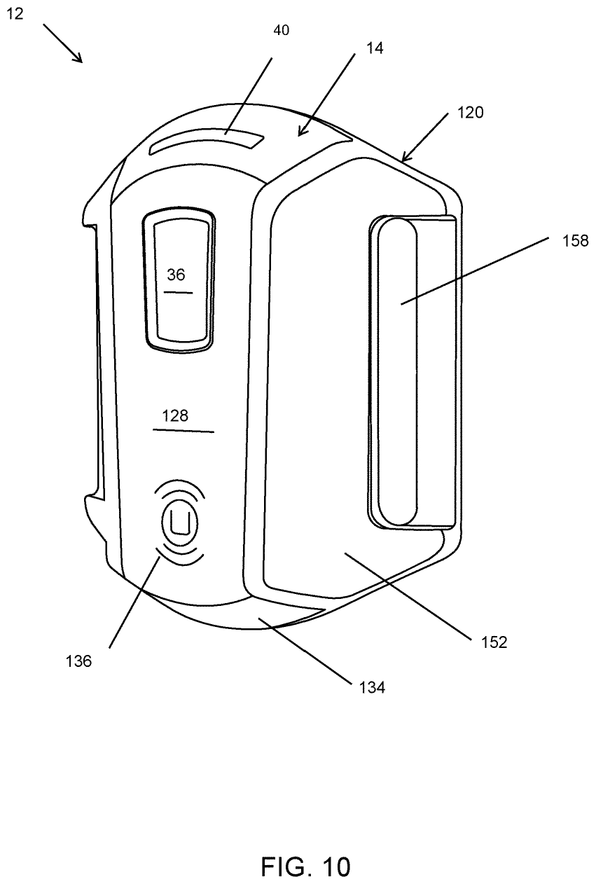

FIG. 10 is a flow diagram of a method for storing the data in the backend server for facilitating building relationship between business and consumers, in accordance with some embodiments. Further, the method may include identifying and verifying a code. Further, the method may include recording the code on the backend server. The data from each server may be stored uniquely on the account of both the business and the user completing the transaction.

The business and the user's accounts may simultaneously record the data from the unique token, including the API metrics. Further, the disclosed system time stamps it along with a date for accurate tracking and data compilation. This finalizes the word-of-mouth relationship resulting in the agreed-upon reimbursement being applied.

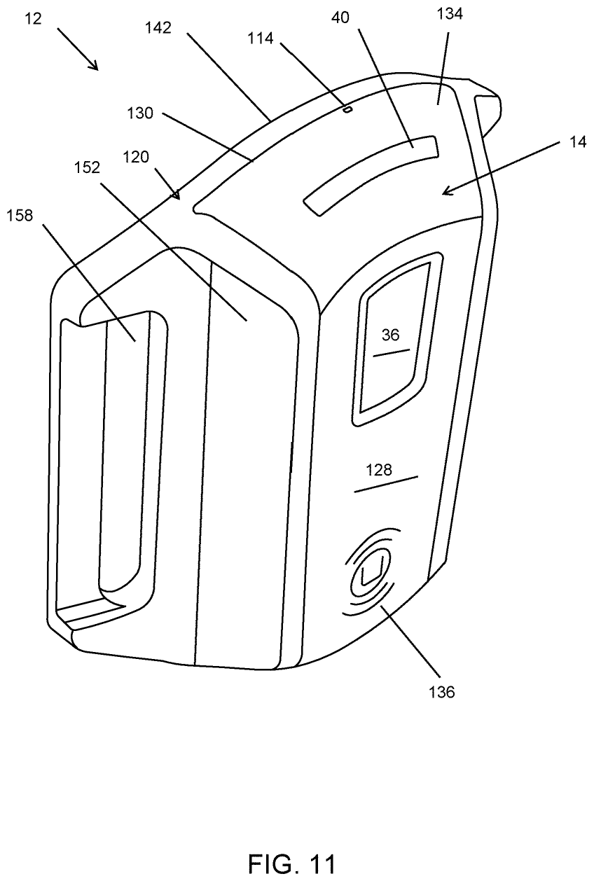

FIG. 11 is a flow diagram of a method for facilitating building relationship between business and consumers, in accordance with some embodiments. Accordingly, the method may include a user registering and downloading a software application. Further, the method may include the user taking an image using checkin/Geotag. Further, at the time of purchase, an image may be verified by a business. Further, the method may include showing a map with business. Further, the method may include detailing participating businesses and relevant information. Further, the method may include the disclosed system tracking the business and the user (or client). Further, the method may include the business scanning and confirming use of the image and thus preventing duplicate usage.

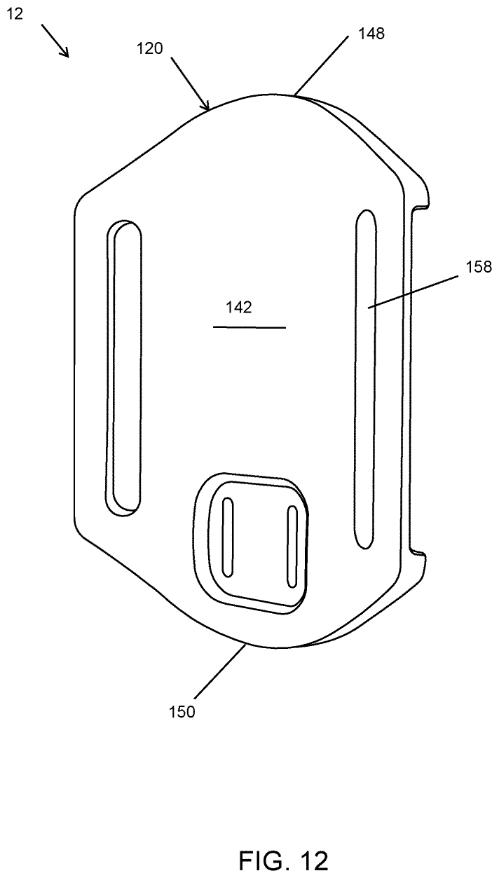

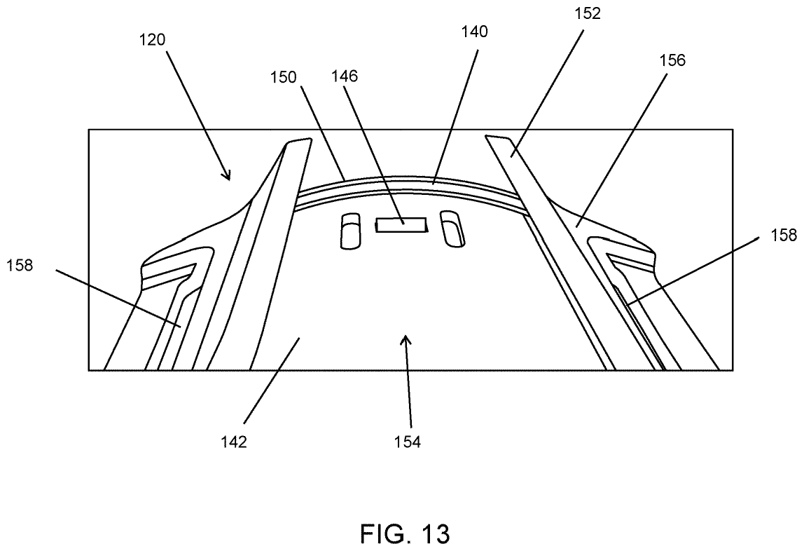

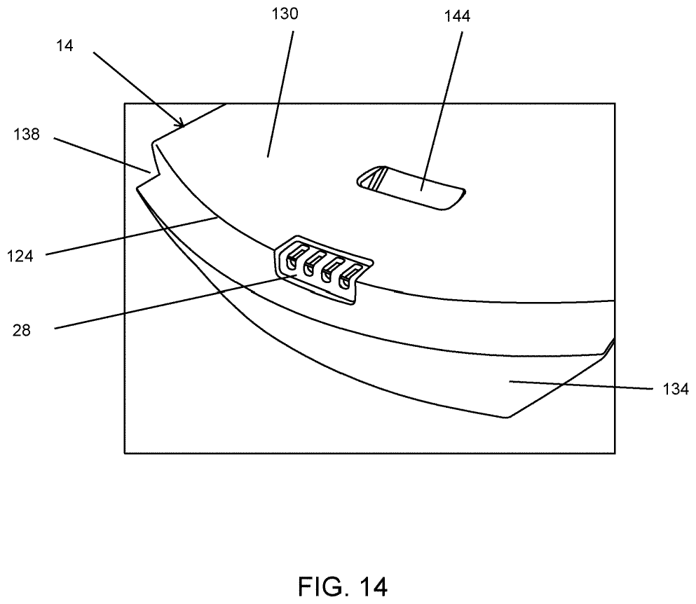

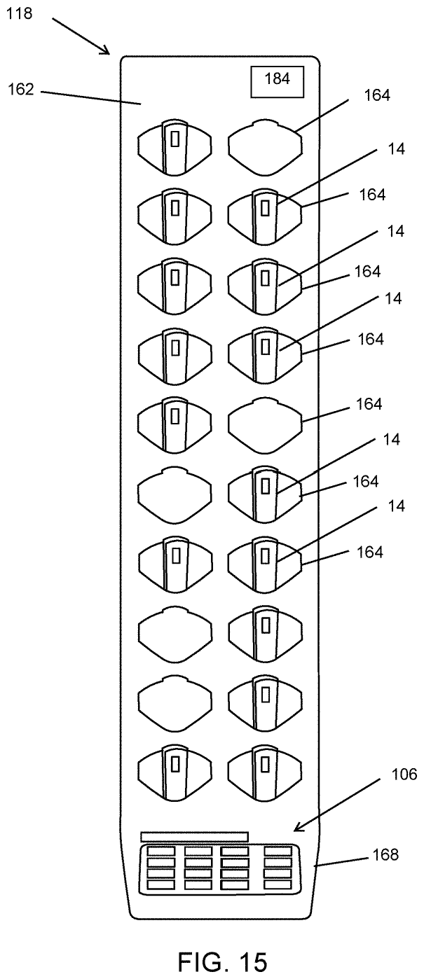

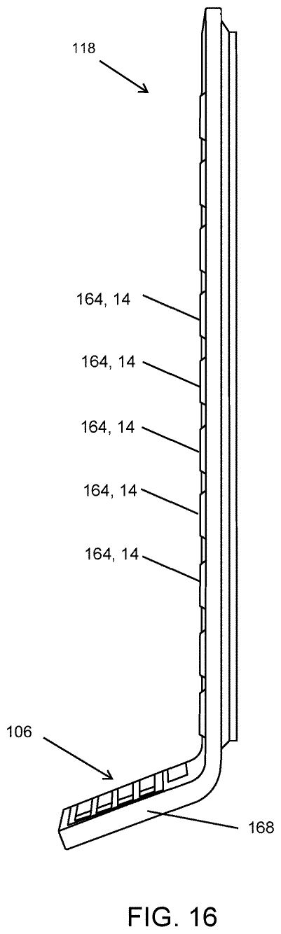

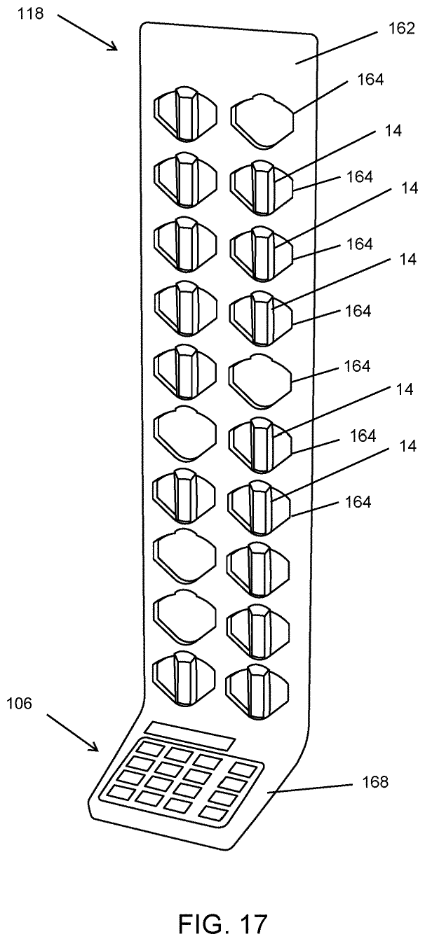

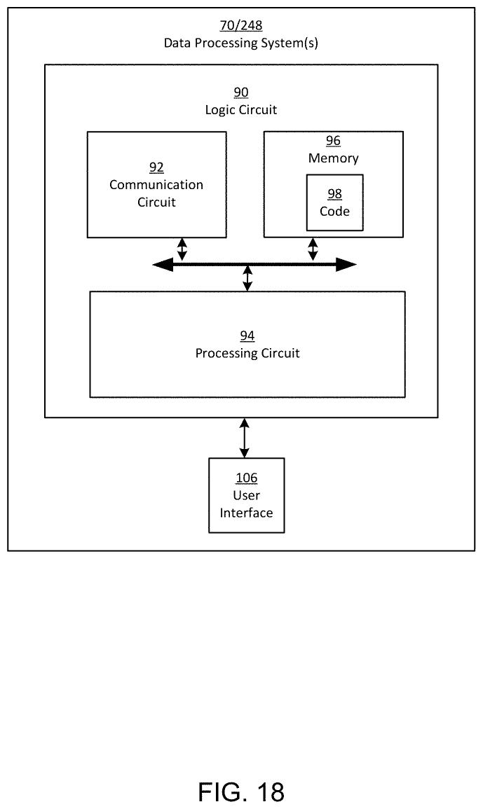

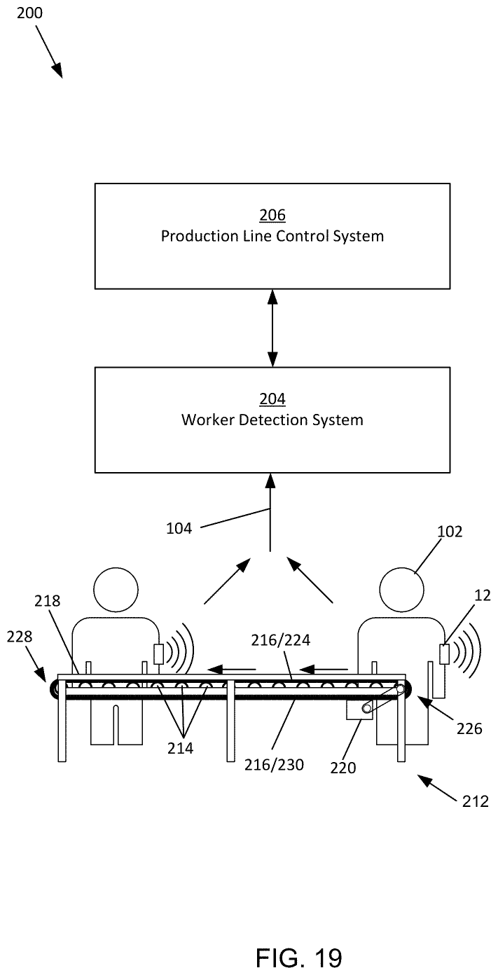

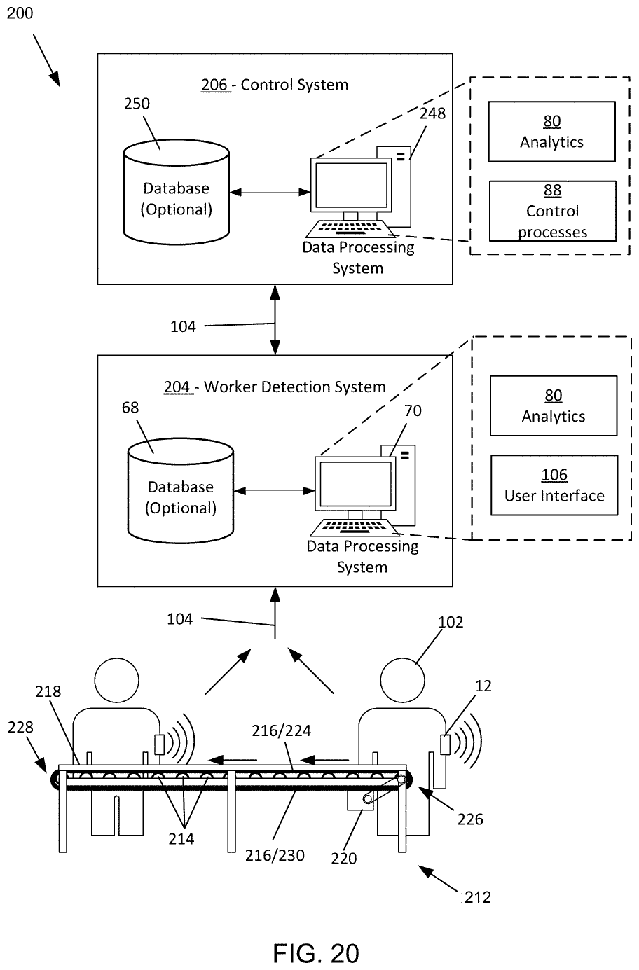

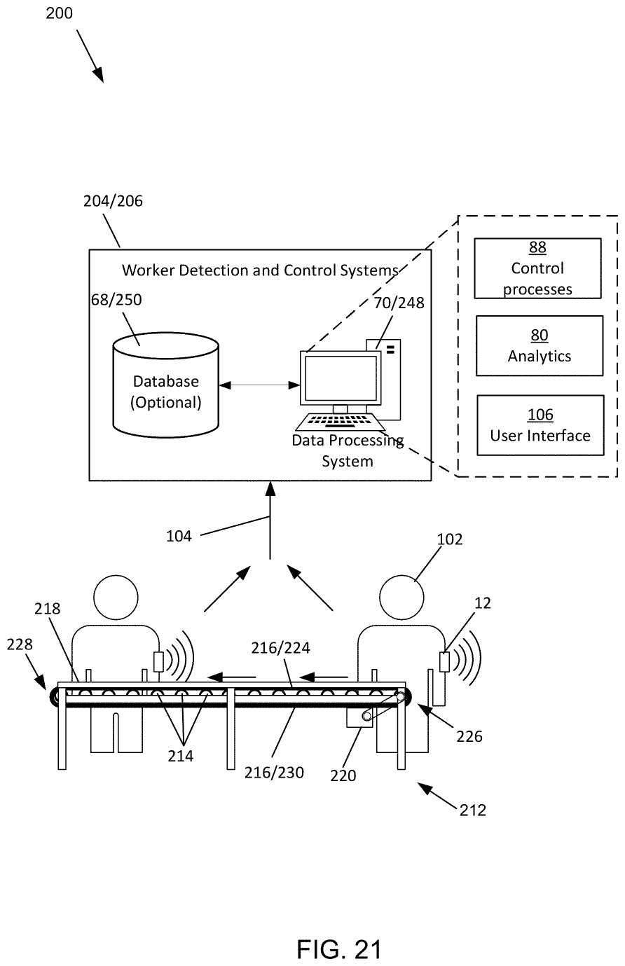

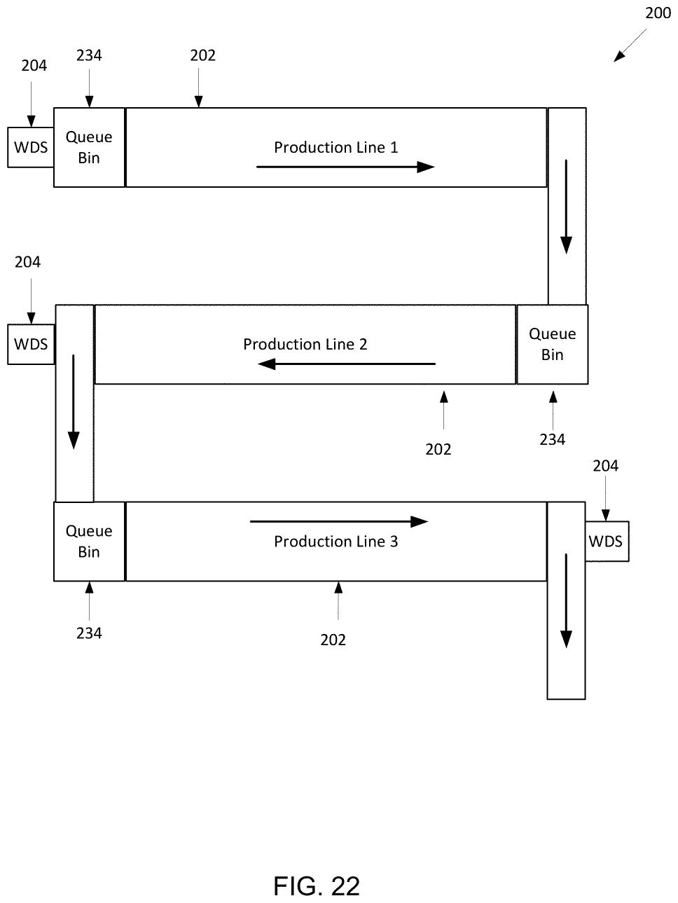

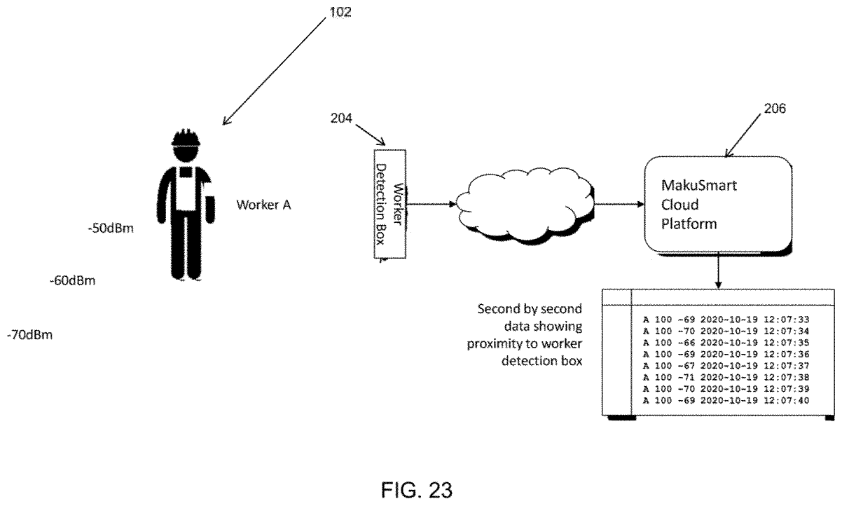

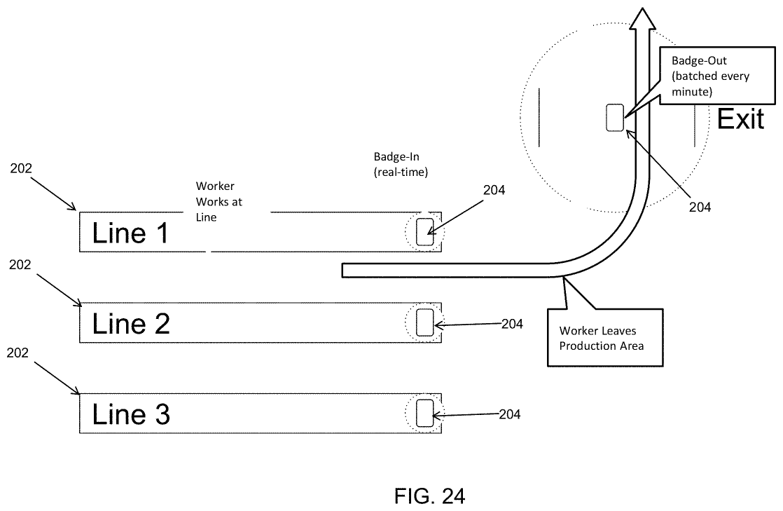

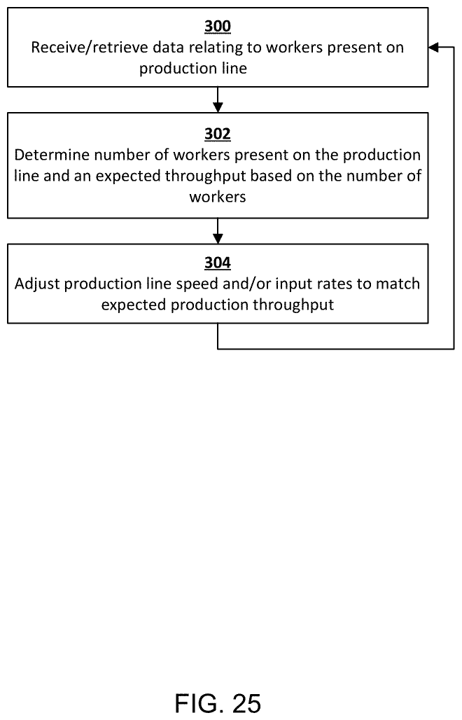

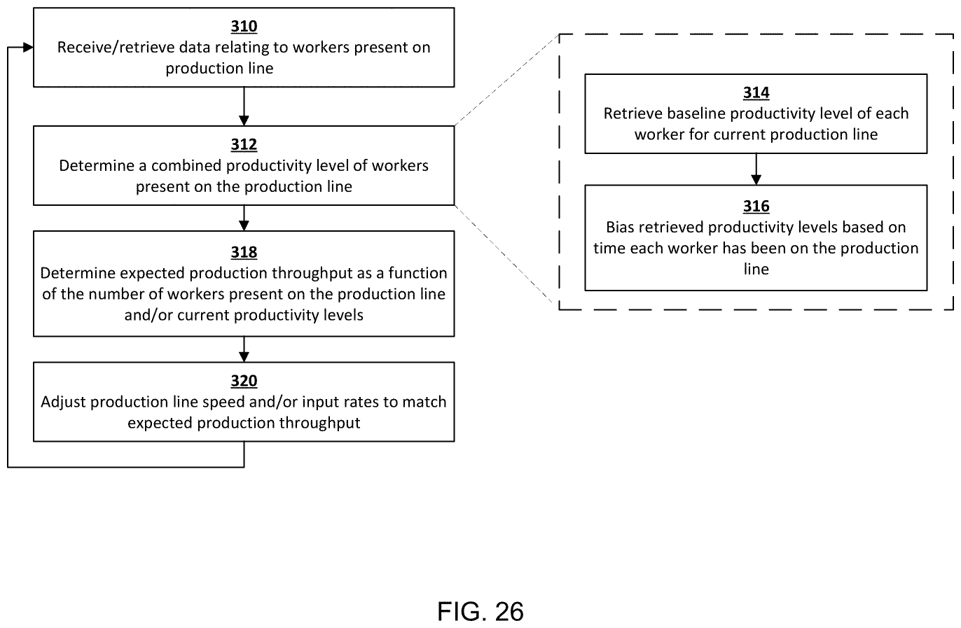

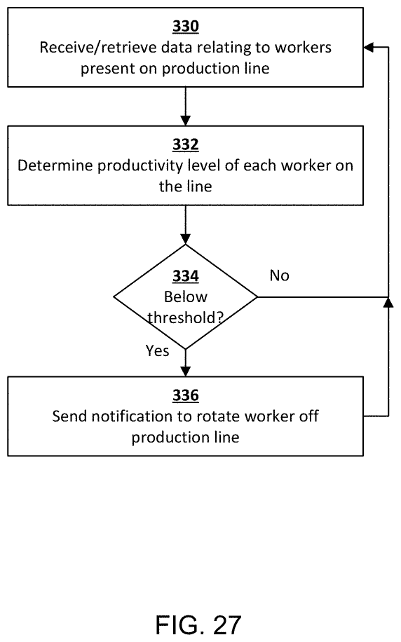

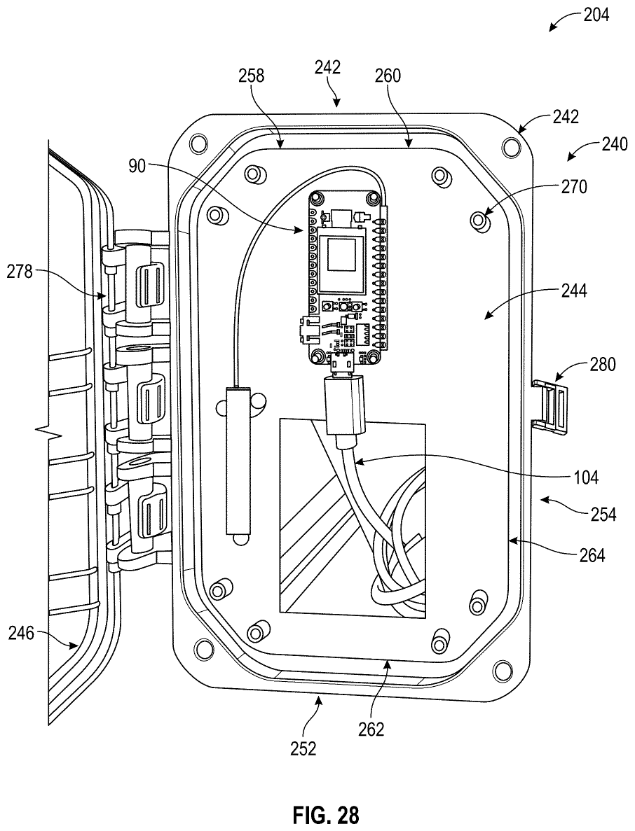

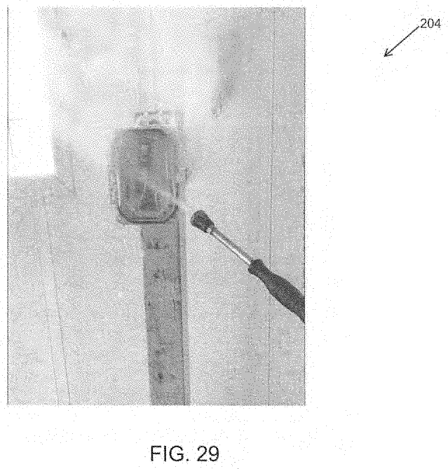

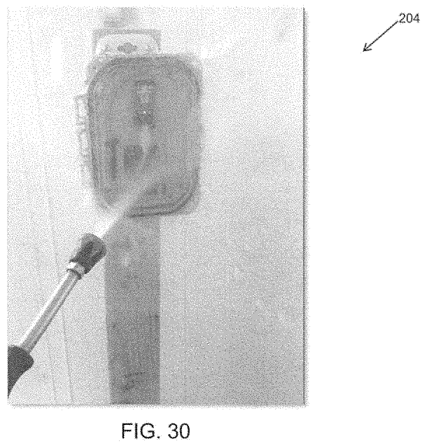

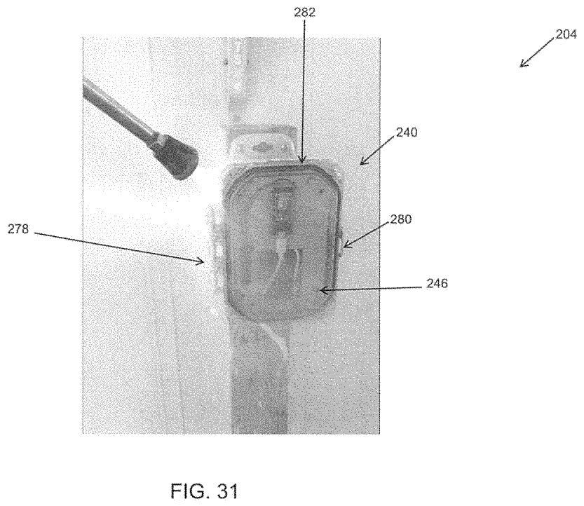

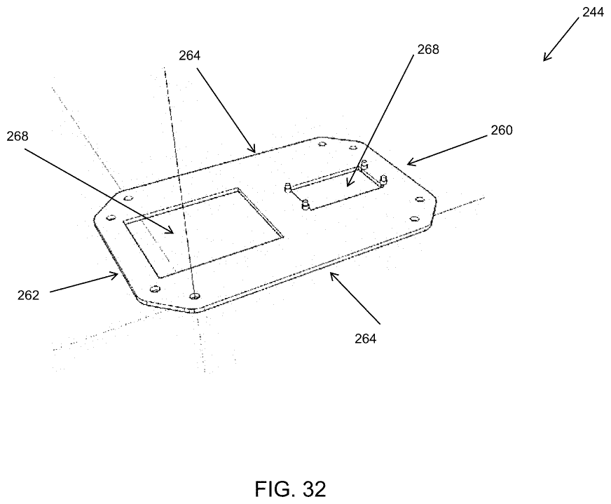

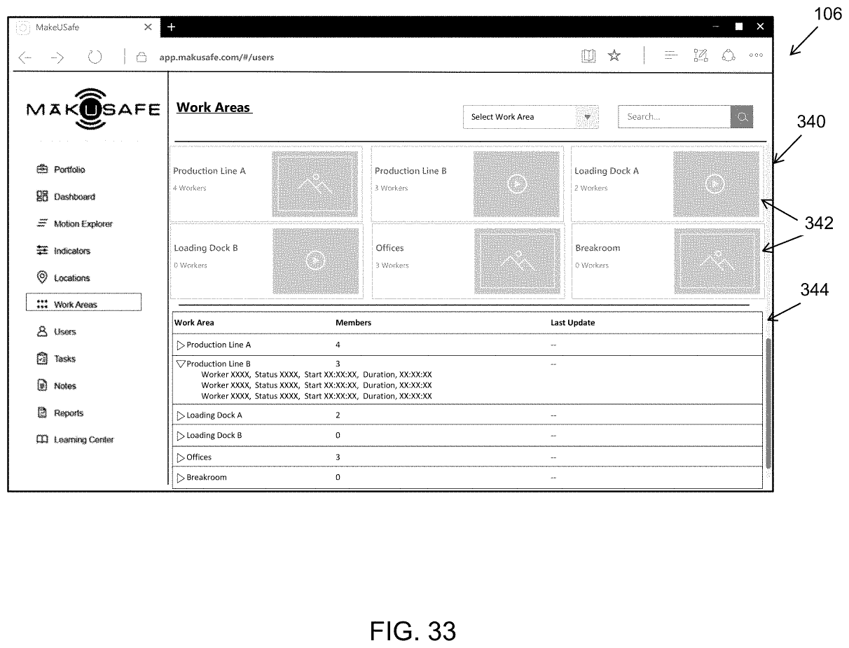

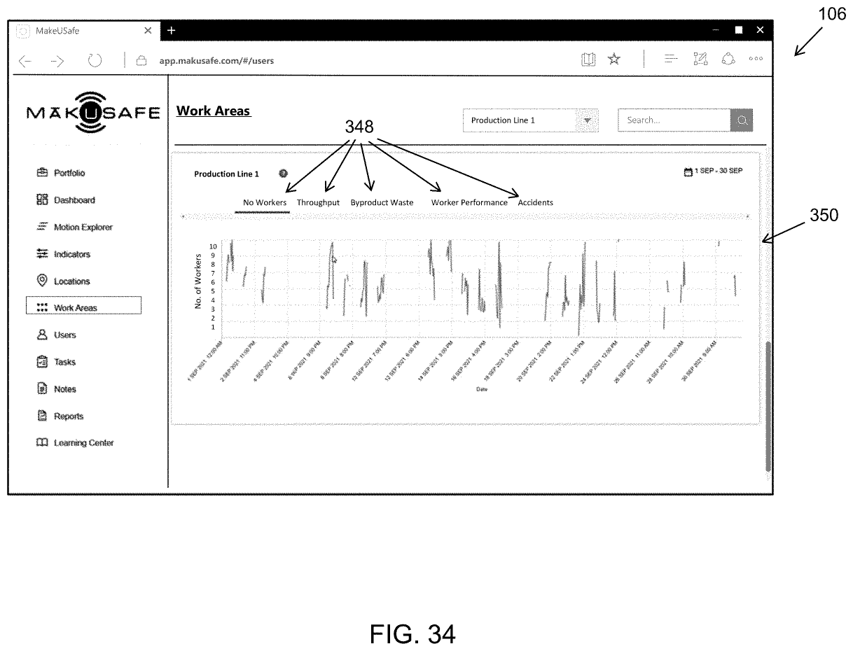

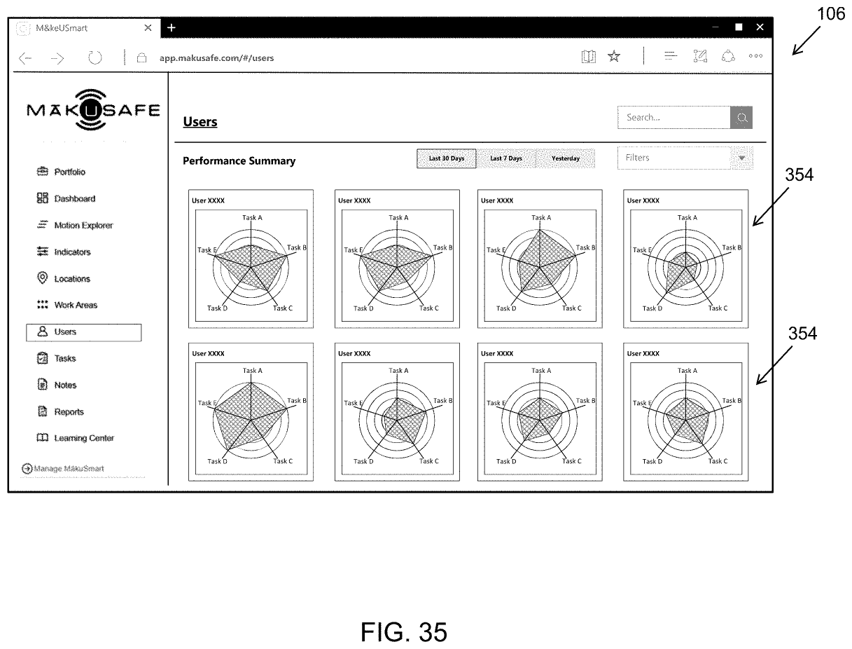

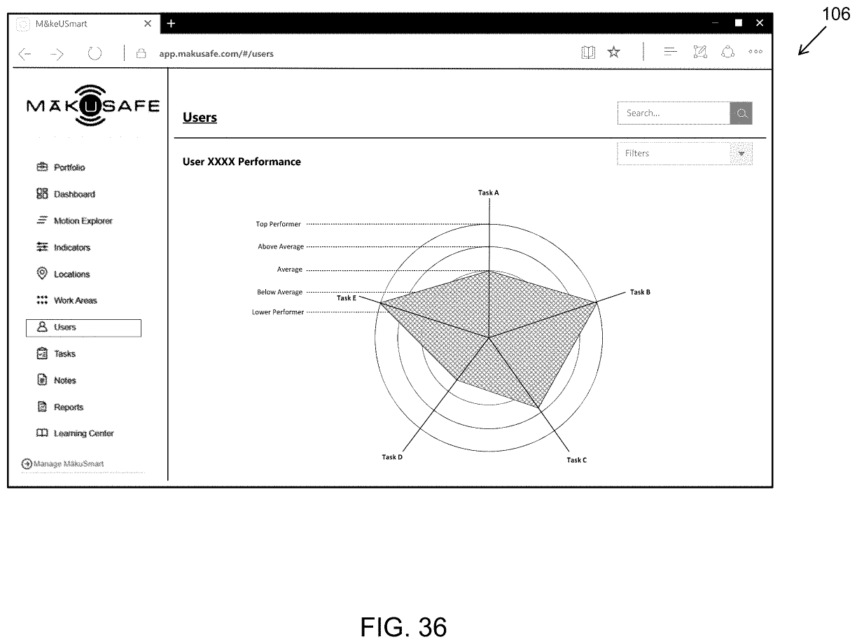

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g., random-access memory (RAM)), non-volatile (e.g., read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include image-processing module, machine learning module, and/or image classifying module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and nonvolatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1204, including operating system 1205. While executing on processing unit 1202, programming modules 1206 (e.g., application 1220 such as a media player) may perform processes including, for example, one or more stages of methods, algorithms, systems, applications, servers, databases as described above. The aforementioned process is an example, and processing unit 1202 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method of facilitating building relationship between business and consumers, the method comprising the steps of:
receiving, using a communication device, a user identifier from at least one user device associated with at least one user, wherein the user identifier facilitates determining an identity of the at least one user, and wherein the identity includes a business organization and a customer;
retrieving, using a storage device, a user registration module based on the user identifier, wherein the user registration module includes a plurality of fields;
transmitting, using the communication device, the user registration module to the at least one user device;
receiving, using the communication device, user details corresponding to the user registration module from the at least one user device, wherein the user details include a username, a contact number, email address, a contact address, etc;
analyzing, using a processing device, the user details and the user registration module for generating a user account, wherein the generating of the user account facilitates registering of the at least one user on the software platform, and wherein the user account may be associated with a user id and password;
receiving, using the communication device, a content of a user activity from at least one input device, wherein the user activity includes at least one customer capturing the content at a location;
transmitting, using the communication device, the content to an external server, wherein the external server is associated with a social media platform.
processing, using the processing device, the content;
identifying, using the processing device, a verification associated with a user activity based on the processing, wherein the verification includes verifying a location of the user activity, and wherein the verifying includes confirming the location of the content associated with the user activity;
determining, using the processing device, metrics based on the processing;
determining, using the processing device, a word-of-mouth activity based on the determining of the metrics, wherein the word-of-mouth activity includes the at least one customer recommending at least one business associated with at least one business administrator;
determining, using the processing device, a reward token based on the word-of-mouth activity generated through the behaviors described above;
transmitting, using the communication device, the reward token to at least one customer device associated with the at least one customer;
storing, using the storage device, the reward token, a verification, and the word-of-mouth activity on a blockchain;
generating, using the processing device, crypto token based on the word-of-mouth activity, wherein the crypto token is associated with a cryptocurrency;
transmitting, using the communication device, the crypto token to the at least one customer device; and
receiving, using the processing device, sensor data from at least one sensor, wherein the at least one sensor is a physiological sensor, an audio sensor, point of sale (Pos System), or a combination thereof, wherein the physiological sensor is configured for determining emotions of the at least one customer, and wherein the determining of the word-of-mouth activity may be based on the sensor data.
